(19) United States
(12) Patent Application Publication
(10) Pub. No.: US 2013/0064714 A1
(43) Pub. Date: Mar. 14, 2013

(54) CHIP FOR FLUID ANALYSIS

(71) Applicants: Dae Sung Hur, Suwon-si (KR); Ji Young Park, Seoul (KR)

(72) Inventors: Dae Sung Hur, Suwon-si (KR); Ji Young Park, Seoul (KR)

(73) Assignee: Nanoentek Inc., Seoul (KR)

(21) Appl. No.: 13/698,697

(22) PCT Filed: May 17, 2011
(86) PCT No.: PCT/KR2011/003658

§ 371 Date: Nov. 19, 2012

(30) Foreign Application Priority Data
May 18, 2010 (KR) 1020100046257

(51) Int. Cl. G01N 21/64

(52) U.S. Cl. 422/69

(57) ABSTRACT

Disclosed herein is a chip for analyzing fluids which restricts the flow of a fluid and the flow velocity of the fluid at a reaction unit, where an antigen-antibody reaction occurs, to increase reactivity and sensitivity.

### TECHNICAL FIELD

The present invention relates to a chip for analyzing fluids, and more particularly to a chip for analyzing fluids which restricts the flow of a fluid and the flow velocity of the fluid at a reaction unit, where an antigen-antibody reaction occurs, to increase reactivity and sensitivity.

### BACKGROUND ART

In general, analysis of fluid samples has been widely used not only in chemistry and biotechnology but also in diagnosis through analysis of blood and bodily fluids extracted from a patient.

Recently, in order to more conveniently and effectively perform such analysis of fluid samples, various kinds of small-sized analysis and diagnosis equipment have been developed.

Particularly, lab-on-a-chip technology refers to technology which implements various experimental processes performed in a laboratory, such as separation, purification, mixing, labeling, analysis, washing, etc. of samples, on a small-sized chip using micro-fluidics, etc.

Various applications of such lab-on-a-chip technology, such as development of a portable DNA analysis apparatus for personal identification which may perform a process from DNA extraction to analysis on a chip once, have been vigorously carried out in respective industrial fields.

Further, in in vitro diagnostics, research on a portable diagnostics tool, i.e., point of care testing (POCT), which allows an individual to easily and directly perform complicated precise testing of blood and bodily fluids, performed in hospitals or laboratories, in the field, has been vigorously carried out.

POCT refers to field diagnosis technology through which a disease may be simply diagnosed on a medical field, such as an emergency room, an operating room or a general home, and necessity and demand for POCT are gradually increased by way of precaution for aging and a welfare society. A diagnostic tool for measuring blood glucose is mainly on the market now, but as substantial demand for POCT increases, demand for a diagnostic tool for analyzing various biological materials, such as lactic acid, cholesterol, urea and infectious pathogens, rapidly increases.

These analysis and diagnosis technologies are generally performed by detecting and analyzing whether or not various fluid samples react with antibody proteins fixed within a chip or other samples through various methods while moving the fluid samples through a micro channel formed within the chip.

The lab-on-a-chip technology regarding such detection and analysis means that various experimental processes performed in a laboratory, such as separation, purification, mixing, labeling, analysis, washing, etc. of samples, are implemented on a small-sized chip. Techniques regarding micro-fluidics and a micro-LHS are mainly used in design of a lab-on-a-chip. Further, as a chip structure implementing micro-fluidics and a micro-LHS, a chip in which a micro channel are formed using a semiconductor circuit design technology is on the market.

Hereinafter, a process of analyzing an analyte of an extremely small quantity from a fluid sample, such as blood or a bodily fluid, generally using a lab-on-a-chip will be described according to a moving path of the fluid sample with reference to FIGS. 1 to 3 illustrating a conventional chip 10 for analyzing fluids.

First, a fluid sample (not shown) is injected into a chip 10 through a fluid inlet 21 formed at one side end on an upper plate 11 forming the chip 10, and then the fluid sample flows to the other side end of the chip 10 within a channel 22 formed in the chip 10 by means of surface tension between the fluid sample and channel inner walls 22a, 22b, 22c and 22d and capillary force. Such a channel 22 is formed by a height difference between the upper plate 11 and a lower plate 12, and an opening 23 is provided at the downstream part of the channel 22.

The fluid sample flowing through the channel 22 passes through a conjugation unit 30 including labels to conjugate with an analyte in the fluid sample and a reaction unit 40 in which a probe to fix the analyte is attached to the inner wall of the channel 22. While the analyte in the fluid sample passes through the reaction unit 40, the position of the analyte is fixed to the corresponding channel inner wall (a detection unit) 22a, 22b, 22c or 22d to which antibodies are fixed by the probe.

Since the labels include a fluorescent material, detecting light may be indirectly irradiated to the analyte present in the fluid sample by inspecting the intensity of light detected by irradiating the detecting light to the reaction unit 40. However, many labels, such as labels which do not conjugate with the analyte or labels which conjugate with the analyte but are not fixed by the probe and float, may be present in the reaction unit 40.

Therefore, in order to achieve precise detection, a process of removing these floating labels from the reaction unit 40 is essentially required, and thus a removal process is carried out by performing washing in which the flow velocity of the fluid sample increases more than a designated value to remove the floating labels present in the reaction unit 40.

However, as such washing is performed simultaneously with an antigen-antibody reaction, the antigen-antibody reaction in the reaction unit 40 may be disturbed by flow of the fluid sample. That is, as the fluid sample continuously flows in the reaction unit 40, the antigen-antibody reaction is not properly performed and thus the analyte contained in the fluid sample is not properly fixed to the antibodies by the probe. This may cause irregularity in reproducibility and sensitivity in reaction in the chip 10.

Therefore, a chip for analyzing fluids which excludes the flow of a fluid until an antigen-antibody reaction in a reaction unit is sufficiently carried out and performs washing of floating labels present in the reaction unit after the antigen-antibody reaction is sufficiently carried out, has been required.

### DISCLOSURE

### Technical Problem

Therefore, the present invention has been made in view of the above problems, and it is an object of the present invention to provide a chip for analyzing fluids which restricts the flow of a fluid and the flow velocity of the fluid at a reaction unit, where an antigen-antibody reaction occurs, to increase reactivity and sensitivity.

### Technical Solution

In accordance with an aspect of the present invention, the above and other objects can be accomplished by the provision of a chip for analyzing fluids including a main body provided with an inlet through which a fluid is injected into the chip for analyzing fluids, at least one reaction channel, which branches off from the main body and serves as an independent channel to which the fluid moves, and in which a reaction of an analyte contained in the fluid occurs, and at least one washing channel formed within the main body and filled with the fluid coming out of the at least one reaction channel after the reaction has been completed.

The downstream end of the at least one reaction channel may be an open end, and the downstream end of the least one washing channel may be a closed end.

The chip for analyzing fluids may further include at least one separation plate provided on the at least one washing channel and opening a part of the main body to deform the downstream end of the at least one washing channel into an open end when chemical treatment or thermal treatment of the at least one separation plate is performed or physical force is applied to the at least one separation plate.

At least one absorption pad to absorb or move the fluid may be inserted into the at least one washing channel.

The at least one reaction channel and the at least one washing channel may sequentially control the flow of the fluid through opening of the at least one separation plate.

The at least one reaction channel may branch off from the main body at a designated angle to the at least one washing channel, and preferably at right angles to the at least one washing channel.

The main body may be formed by connecting an upper plate and a lower plate, and the chip for analyzing fluids may further include at least one joining solvent inlet through which a joining solvent to join the upper plate and the lower plate is injected into the chip for analyzing fluids.

The at least reaction channel may be formed by connecting a capillary tube plate formed integrally with the main body and a reaction slide inserted into an insertion groove formed on the main body.

At least a part of the at least one reaction channel may have a slope gradient such that a height difference of the reaction channel is gradually increased in the downstream direction, and a resistance part decreasing the width of the at least one reaction channel may be provided at at least a part of the at least one reaction channel.

In accordance with another aspect of the present invention, there is provided a chip for analyzing fluids a reaction unit provided with a reaction channel in which a fluid injected through an inlet into the chip for analyzing fluids flows and a reaction of an analyte contained in the fluid occurs, and a main body provided with a washing channel which is filled with the fluid coming out of the reaction channel after the reaction has been completed, wherein the reaction unit is connected to the main body so as to branch off from the main body at a designated angle.

The reaction unit may include a capillary tube plate formed integrally with the main body and a reaction slide inserted into an insertion groove formed on the main body, or may be integrally formed and inserted into an insertion groove formed on the main body.

### Advantageous Effects

The chip for analyzing fluids in accordance with the present invention has effects, as below.

First, the chip for analyzing fluids restricts the flow of a fluid and the flow velocity of the fluid at a reaction unit, where an antigen-antibody reaction occurs, thus increasing reactivity and sensitivity.

Second, the chip for analyzing fluids separates a section where the reaction occurs from a section where the fluid proceeds and performs the reaction and washing by stages, thus securing reliability and stability in a reaction result.

Third, the chip for analyzing fluids simply performs the washing stage only by removing a separation plate from a main body, thus providing convenience in user operation.

Fourth, the chip for analyzing fluids removes all materials of the fluid except for an analyte taking part in the reaction in the washing stage, thus precisely detecting the analyte.

### DESCRIPTION OF DRAWINGS

The above and other objects, features and other advantages of the present invention will be more clearly understood from the following detailed description taken in conjunction with the accompanying drawings, in which:

FIG. 1 is a schematic perspective view of a conventional chip for analyzing fluids;

FIG. 2 is a longitudinal-sectional view of the chip for analyzing fluids of FIG. 1;

FIG. 3 is a cross-sectional view of the chip for analyzing fluids of FIG. 1;

FIG. 4 is a perspective view of a chip for analyzing fluids in accordance with a first embodiment of the present invention;

FIG. 5 is a partial perspective view of the chip for analyzing fluids in accordance with the first embodiment of the present invention in a state in which a reaction slide is removed;

FIG. 6 is a partial perspective view of the chip for analyzing fluids in accordance with the first embodiment of the present invention in a state in which the reaction slide is separated;

FIG. 7 is a perspective view of the chip for analyzing fluids in accordance with the first embodiment of the present invention in a state in which a lower plate is removed, as seen from the bottom;

FIG. 8 is a partial perspective view of a chip for analyzing fluids in accordance with a second embodiment of the present invention in a state in which a reaction slide is removed;

FIG. 9 is a perspective view of the chip for analyzing fluids in accordance with the second embodiment of the present invention in a state in which a lower plate is removed, as seen from the bottom;

FIG. 10 is a partial perspective view of a chip for analyzing fluids in accordance with a third embodiment of the present invention in a state in which reaction slides are removed;

FIG. 11 is a perspective view of the chip for analyzing fluids in accordance with the third embodiment of the present invention in a state in which a lower plate is removed, as seen from the bottom;

FIG. 12 is a partial perspective view of a chip for analyzing fluids in accordance with a fourth embodiment of the present invention in a state in which a reaction slide is removed;

FIG. 13 is a partial perspective view of the chip for analyzing fluids in accordance with the fourth embodiment of the present invention in the state in which the reaction slide is removed, as seen from a different angle;

FIG. 14 is a perspective view of the chip for analyzing fluids in accordance with the fourth embodiment of the present invention in a state in which a lower plate is removed, as seen from the bottom;

FIG. 15 is a partial plan view illustrating the flow of a fluid in the chip for analyzing fluids in accordance with the fourth embodiment of the present invention;

FIG. 16 is a graph representing reaction sensitivities of serum Trophonin I (TnI) according to concentration, measured using a chip for analyzing fluids in accordance with the present invention; and

FIG. 17 illustrates four capture images of serum TnI according to concentration, measured using the chip for analyzing fluids in accordance with the present invention.

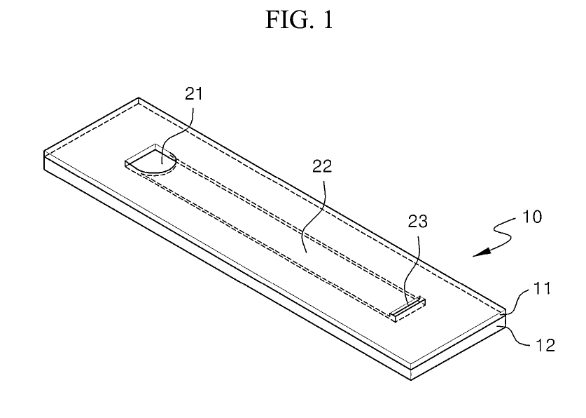

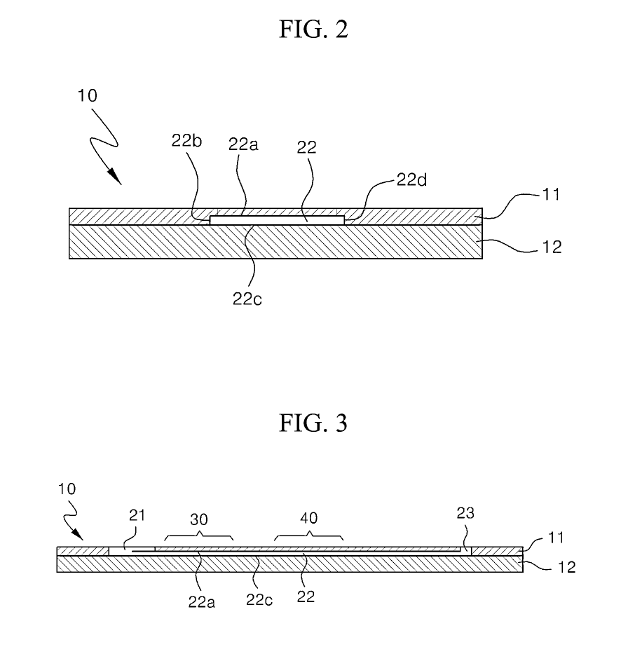

### BEST MODE

Now, preferred embodiments in accordance with the present invention will be described in detail with reference to the annexed drawings. The present invention is not limited to the embodiments, and those skilled in the art will appreciate that various modifications, additions and substitutions are possible. The embodiments are exemplarily provided only to thoroughly and completely describe the subject matter of the present invention and to sufficiently convey the sprit of the present invention to those skilled in the art. In the following description, the same or similar elements are denoted by the same reference numerals even though they are depicted in different drawings.

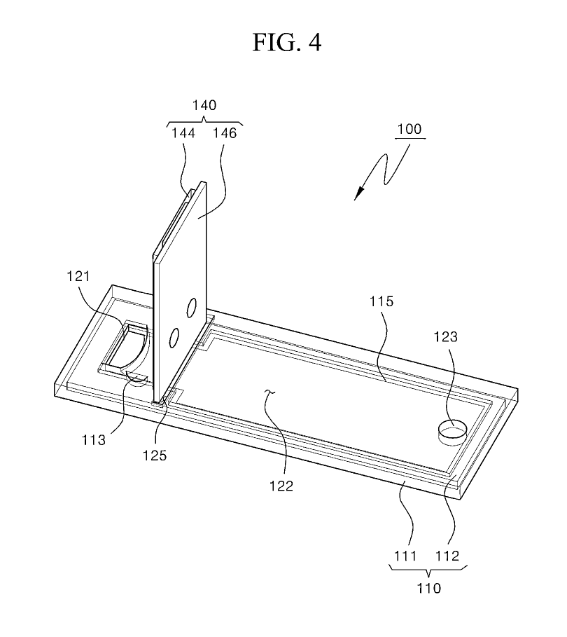

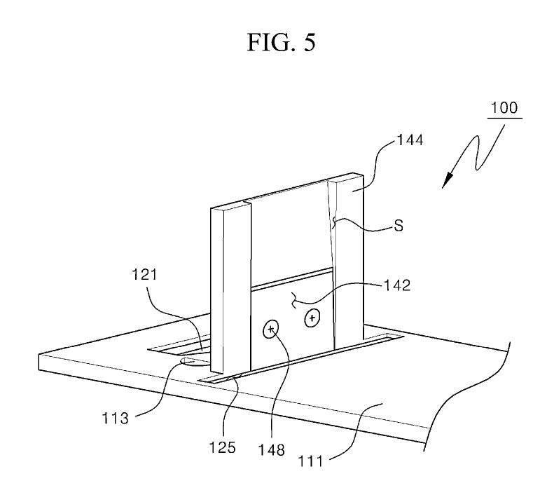

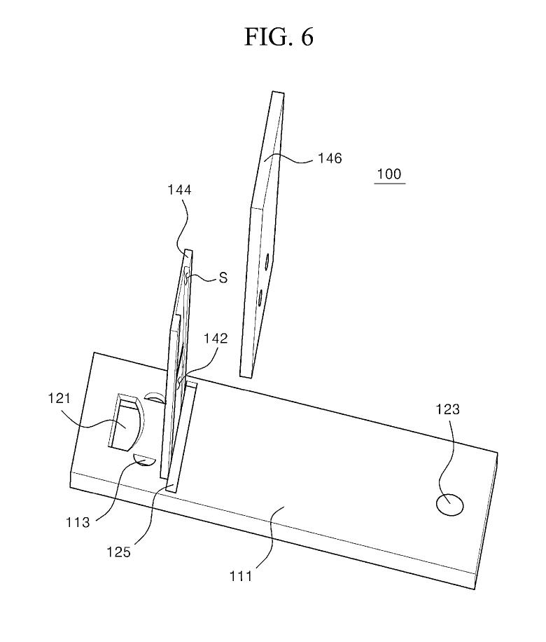

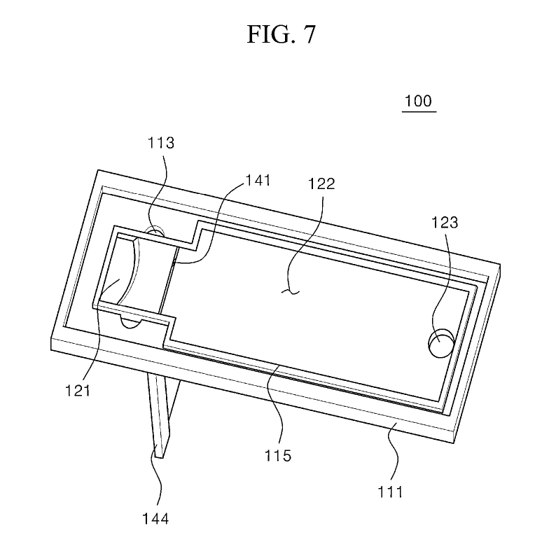

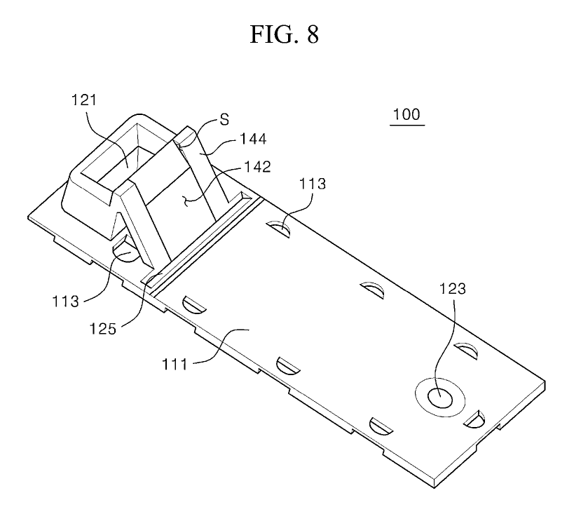

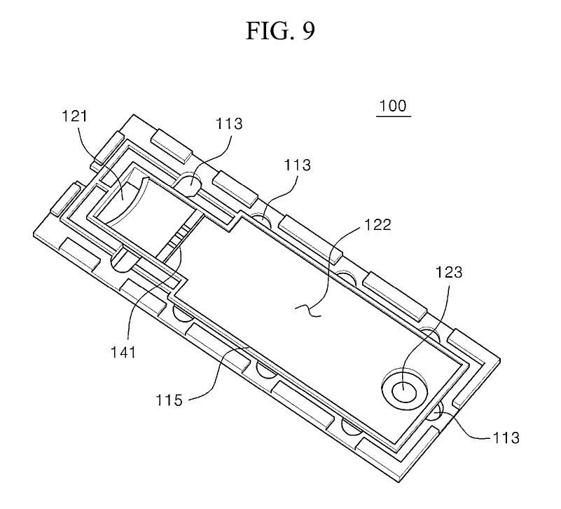

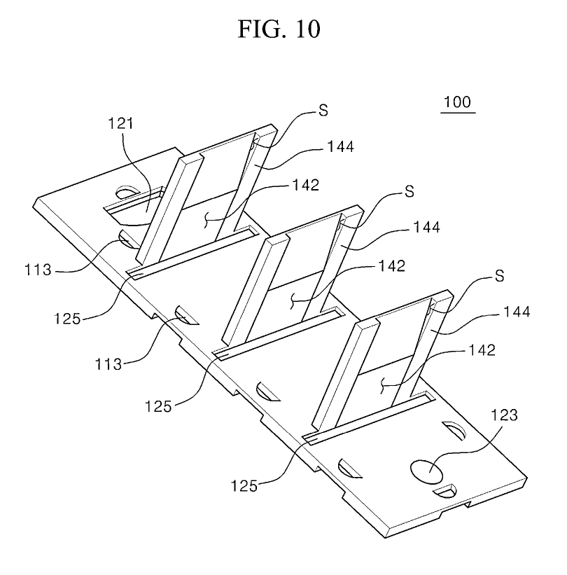

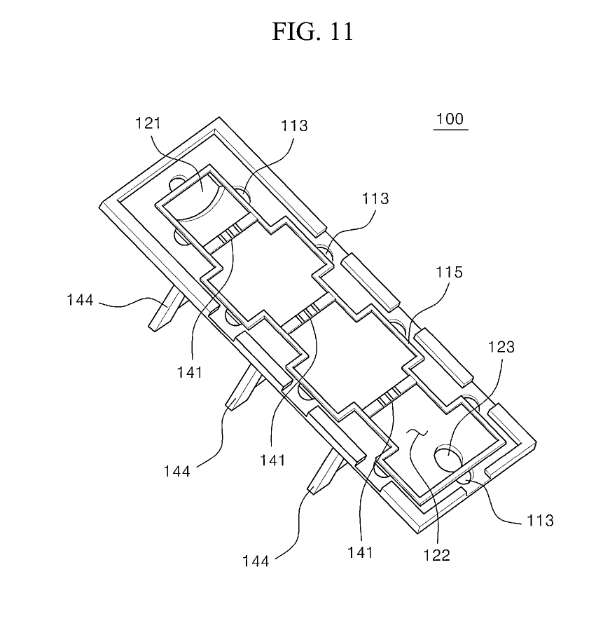

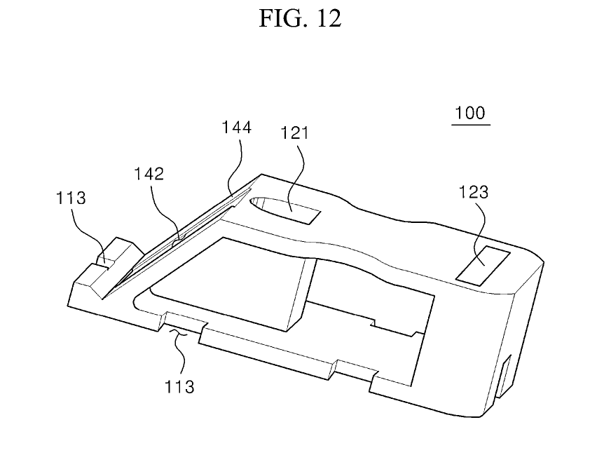

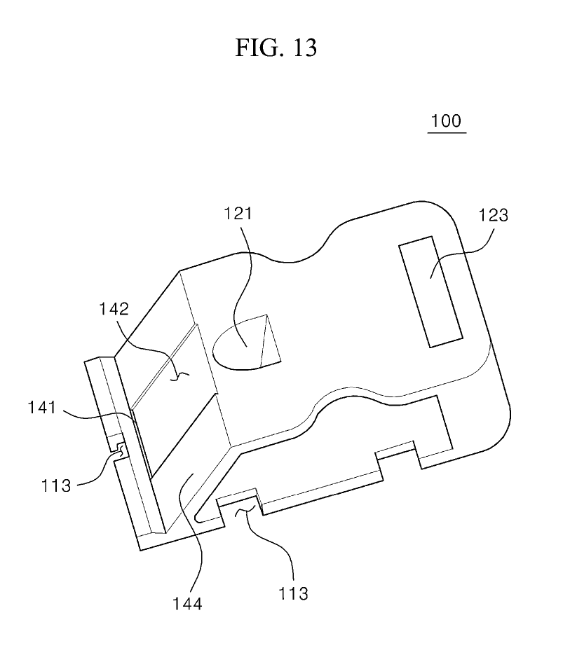

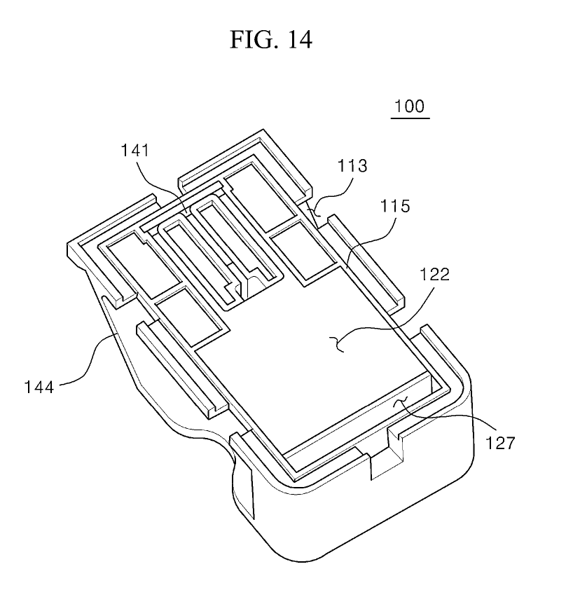

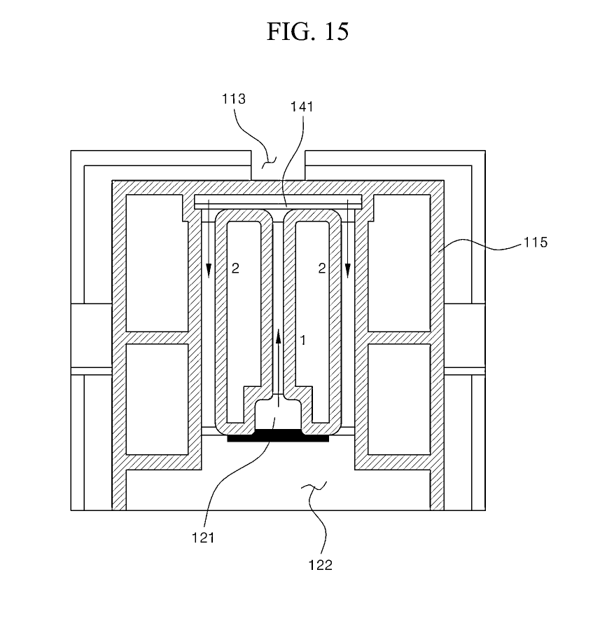

FIG. 4 is a perspective view of a chip for analyzing fluids in accordance with a first embodiment of the present invention, FIG. 5 is a partial perspective view of the chip for analyzing fluids in accordance with the first embodiment of the present invention in a state in which a reaction slide is removed, FIG. 6 is a partial perspective view of the chip for analyzing fluids in accordance with the first embodiment of the present invention in a state in which the reaction slide is separated, FIG. 7 is a perspective view of the chip for analyzing fluids in accordance with the first embodiment of the present invention in a state in which a lower plate is removed, as seen from the bottom, FIG. 8 is a partial perspective view of a chip for analyzing fluids in accordance with a second embodiment of the present invention in a state in which a reaction slide is removed, FIG. 9 is a perspective view of the chip for analyzing fluids in accordance with the second embodiment of the present invention in a state in which a lower plate is removed, as seen from the bottom, FIG. 10 is a partial perspective view of a chip for analyzing fluids in accordance with a third embodiment of the present invention in a state in which reaction slides are removed, FIG. 11 is a perspective view of the chip for analyzing fluids in accordance with the third embodiment of the present invention in a state in which a lower plate is removed, as seen from the bottom, FIG. 12 is a partial perspective view of a chip for analyzing fluids in accordance with a fourth embodiment of the present invention in a state in which a reaction slide is removed, FIG. 13 is a partial perspective view of the chip for analyzing fluids in accordance with the fourth embodiment of the present invention in the state in which the reaction slide is removed, as seen from a different angle, FIG. 14 is a perspective view of the chip for analyzing fluids in accordance with the fourth embodiment of the present invention in a state in which a lower plate is removed, as seen from the bottom, and FIG. 15 is a partial plan view illustrating the flow of a fluid in the chip for analyzing fluids in accordance with the fourth embodiment of the present invention.

With reference to FIGS. 4 to 15, a chip 100 for analyzing fluids in accordance with the present invention includes a main body 110 provided with an inlet 121 through which a fluid is injected into the chip 100 for analyzing fluids, at least one reaction channel 142, which branches off from the main body 110 and serves as an independent channel to which the injected fluid moves, and in which a reaction of an analyte contained in the fluid occurs, and at least one washing channel 122 formed within the main body 110 and filled with the fluid coming out of the reaction channel 142 after the reaction has been completed.

The inlet 121 may be provided at one end of the main body 110, and the fluid containing the analyte is injected into the chip 100 for analyzing fluids through the inlet 121. The main body 110 may be formed by connecting an upper plate 111 and a lower plate 112. Preferably, the inlet 121 is formed on the upper plate 111.

A joint part 115 is provided on the lower surface of the upper plate 111. The joint part 115 contacts the upper surface of the lower plate 112, and forms an inner wall of a micro channel formed within the main body 110.

In order to join the upper plate 111 and the lower plate 112, at least one joining solvent inlet 113 through which a joining solvent is injected into the chip 100 for analyzing fluids may be provided. That is, the joining solvent may be used to join the joining part 115 and the lower plate 112 so as to fix them, and the joining solvent is injected into the chip 100 for analyzing fluids through the joining solvent inlet 113.

Although the first embodiment shown in FIGS. 4 to 7 illustrates two joining solvent inlets 113 as being formed at both sides of the channel 122 adjacent to the inlet 121 through which the fluid is injected into the chip 100 for analyzing fluids, the positions of the joining solvent inlets 113 may be varied as needed, i.e., the joining solvent inlets 113 may be formed at both sides of the central part or both sides of the downstream part of the main body 110, as shown in FIGS. 8 to 15, and the number of the joining solvent inlets 113 may be increased according to the length or width of the channel 122.

In addition to the above joining method, the upper plate 111 and the lower plate 112 may be joined through various joining methods using heat, plasma, pressure, ultrasonic waves, an organic solvent, etc.

The chip 100 for analyzing fluids in accordance with the present invention includes the reaction channel 142 in which a reaction to detect the analyte contained in the fluid sample occurs, and the reaction channel 142 branches off from the main body 110 and serves as an independent channel.

That is, the reaction channel 142 and the washing channel 122 are formed on the same plane as a micro channel formed within the main body as in the conventional chip for analyzing fluids, but the reaction channel 142 branches off from the main body 110 and serves as a channel independent of a micro channel formed within the main body 100 and the micro channel formed within the main body 100 serves as the washing channel 122 filled with the fluid coming out of the reaction channel 142 after the reaction has been completed.

Here, the reaction channel 142 branches off from the main body 110 at an inclination of designated degrees to the washing channel 122, and most preferably branches off from the main body 110 at right angles to the washing channel 122. That is, the reaction channel 142 is formed in a direction at a designated angle to the flow direction of the fluid.

FIGS. 4 to 7 illustrate a chip 100 for analyzing fluids in accordance with the first embodiment of the present invention in which the reaction channel 142 branches off from the main body 110 at right angles to the washing channel 122, and FIGS. 8 and 9 illustrate a chip 100 for analyzing fluids in accordance with the second embodiment of the present invention in which the reaction channel 142 branches off from the main body 110 at an inclination of designated degrees to the washing channel 122. In any case, the reaction channel 142 serves as an independent channel formed in a direction at a designated angle to the flow direction of the fluid.

The reaction channel 142 may be formed by connecting a capillary tube plate 144 formed integrally with the main body 110 and a reaction slide 146 inserted into an insertion groove 125 formed on the main body 110. That is, the capillary tube plate 144 and the reaction slide 146 are connected to form a reaction unit 140, and the reaction channel 142 is formed within the reaction unit 140.

Here, the capillary tube plate 144 and the reaction slide 146 may be joined by a joining solvent. Further, in addition to the above joining method, the capillary tube plate 144 and the reaction slide 146 may be joined through various joining methods using heat, plasma, pressure, ultrasonic waves, an organic solvent, etc.

Further, if the reaction channel 142 branches off from the main body 110 at right angles to the washing channel 122, the reaction unit 140 is substantially connected to the main body 110 at right angles.

Although this embodiment illustrates that the capillary tube plate 144 forming the reaction unit 140 is formed integrally with the main body 110 and the reaction slide 146 is connected to the capillary tube plate 144 to form the reaction unit 140, the capillary tube plate 144 which is a member prepared separately from the main body 110 may be connected to the reaction slide 146 to form the reaction unit 140 independently of the main body 110 and then the entirety of the reaction unit 140 may be inserted into the insertion groove 125.

In any case, the reaction channel 142 communicates with a reaction channel entrance 141 formed on the upper surface of the micro channel formed within the main body 110, and the fluid injected through the inlet 121 is introduced into the reaction channel 142 through the reaction channel entrance 141.

Here, a conjugation unit (not shown) including labels to conjugate with the analyte in the fluid may be provided. The conjugation unit may be provided in the channel 122 adjacent to the inlet 121 through which the fluid is injected into the main body 110 or provided under the reaction channel 142.

Further, a detection unit 148 in which antibodies for detection are fixed are provided on the reaction channel 142, and a reaction reagent (not shown) including a probe to fix the analyte and attached to the inner wall of the channel 142 may be provided around the detection unit 148 or the inlet 121. Therefore, while the analyte in the fluid sample meets with the reaction reagent and passes through the reaction channel 142, the position of the analyte is fixed to the detection unit 148 in which the antibodies for detection are fixed to the inner wall of the reaction channel 142, by the probe.

Since the labels include a fluorescent material, the analyte present in the fluid sample may be detected by inspecting the intensity of light detected by irradiating detecting light to the detection unit 148.

A plurality of reaction channels 142 may branch off from the main body 110 so that detection of the analyte may be carried out several times. For this purpose, FIGS. 10 and 11 illustrate a chip 100 for analyzing fluids in accordance with the third embodiment of the present invention in which a plurality of reaction channels 142 branches off from the main body 110 so as to achieve multi-reaction.

Preferably, the downstream end of the reaction channel 142 is an open end, and the downstream end of the washing channel 122 is a closed end. Therefore, the fluid injected through the inlet 121 does not flow toward the washing channel 122 provided with the closed downstream end thereof, and flows toward the reaction channel 142 provided with the open downstream end thereof.

A separation plate 123 is provided at the downstream part of the washing channel 122. After the reaction is completely carried out in the reaction channel 142, when the closed downstream end of the washing channel 122 is changed to a closed end by opening a part of the main body 110 to the outside by applying physical force, chemical treatment or thermal treatment to the separation plate 123, the fluid sample comes out of the reaction channel 142 and then fills the washing channel 122.

Such a configuration of opening the part of the main body 110 by the separation plate 123 may be modified to other configurations according to the shape of a structure forming the chip 100 for analyzing fluids. In case of a chip 100 for analyzing fluids in accordance with the fourth embodiment of the present invention, as shown in FIGS. 12 to 15, the separation plate 123 is formed on the upper part of the structure, and a separation plate communication hole 127 through which the separation plate 123 and the washing channel 122 communicate with each other may be provided, as shown in FIG. 14.

In this case, when the separation plate 123 is removed, the closed end of the washing channel 122 is changed into an open end through the separation plate communication hole 127, and thus the fluid sample comes out of the reaction channel 142 and then fills the washing channel 122.

At least a part of the reaction channel 142 may have a slope gradient such that a height difference of the reaction channel 142 is gradually increased in the downstream direction. That is, as shown in FIGS. 5 and 6, the inner wall of the reaction channel 142 has a slope S such that the height difference of the reaction channel 142 is gradually increased in the downstream direction.

By forming the slope gradient of the reaction channel 122 in this way, the reaction channel 142 may be designed such that capillary force at the upstream part of the reaction channel 142 is increased. Further, since the angle of the inner wall of the reaction channel 122 is gradually increased in the downstream direction and thus the height difference of the reaction channel 122 is gradually increased, when a part of the main body 110 is opened and thus communicates with the outside after the reaction is completely carried out, the fluid sample may easily come out of the reaction channel 142.

Since the height difference of the reaction channel 122 is gradually increased in the downstream direction, the fluid sample fills only a designated region of the upper part of the reaction channel 122 which is opened. Therethrough, the fluid sample fills only a desired height of the reaction channel 142, i.e., fills only the effective range of the detection unit 148, thereby effectively performing the reaction with respect to the amount of the fluid sample and controlling the velocity of the fluid sample coming out of the reaction channel 142 after the reaction is carried out for a designated time.

Further, if the width of the downstream end of the reaction channel 142 is small, the fluid sample may not come out of the reaction channel 142 by force causing the fluid sample to stay in the reaction channel 142 after the reaction. Therefore, if the width of the reaction channel 142 is increased, force pushing the fluid sample in the atmospheric direction from the opened downstream end of the reaction channel 142 is applied, and, when the separation plate 123 located on the washing channel 122 is opened, the fluid sample may effectively flow to the washing channel 122. An absorption pad (not shown) formed of a material, such as paper or a membrane, may be inserted into the washing channel 122 so as to absorb the fluid sample or to assist flow of the fluid sample.

Further, a resistance part (not shown) decreasing the width of the reaction channel 142 to provide resistance to the flow of the fluid sample may be provided at the upstream part of the reaction channel 142, i.e., a part of the reaction channel into which the fluid sample is injected through the reaction channel entrance 141. This serves to adjust the flow velocity of the fluid sample coming out of the reaction channel 142 into the washing channel 122 when the separation plate 123 is opened after the reaction in the reaction channel 142 for a designated time.

If no resistance decreasing the width of the reaction channel 142 is provided at the downstream part of the reaction channel 142 and thus the width of the reaction channel 142 is relatively large and the flow velocity of the fluid sample is increased, the analyte fixed to the detection unit 148 may separated from the detection unit 148. This may cause instability of the flow of the fluid sample due to a high flow velocity together with loss of the analyte, and cause the fluid sample to come out of the reaction channel 142 under the condition that the interface of the fluid sample has an unstable shape and thus cause the fluid sample to firstly pass through one part of the detection unit 148 provided in the horizontal direction, thus serving as an unstable factor to the reaction. In order to prevent such problems and control the flow velocity of the fluid sample, the resistance part decreasing the width of the reaction channel 142 is provided at the upstream part of the reaction channel 142.

Hereinafter, an operating process of the chip 100 for analyzing fluids in accordance with the present invention will be described.

First, when a fluid sample is injected into the main body 110 through the inlet 121, the fluid sample does not flow toward the washing channel 122 provided with the closed end and flows toward the reaction channel 142 provided with the open end, and a reagent reaction is carried out for a designated time after the fluid sample fills the reaction channel 142.

When the washing channel 122 is opened by removing the separation plate 123 located at the downstream part of the washing channel 122 by applying physical force to the separation plate 123 or performing chemical or thermal treatment on the separation plate 123 after the designated time for the reaction has elapsed, air fully filling the washing channel 122 comes out through the open part of the washing channel 122, and thus the fluid sample filling the reaction channel 142 flows to the washing channel 122 and fills the washing channel 122.

Such order of the flow of the fluid sample may be variously modified according to the shape of the structure forming the chip 100 for analyzing fluids. In the case of the chip 100 for analyzing fluids in accordance with the fourth embodiment of the present invention, as shown in FIG. 15, a fluid sample containing an analyte is injected into the main body 110 through the inlet 121, the fluid flows in a direction 1. Here, the fluid sample does not flow toward the washing channel 122 provided with the closed end and flows toward the reaction channel 142 provided with the open end, and a reagent reaction is carried out for a designated time after the fluid sample fills the reaction channel 142.

Thereafter, when the washing channel 122 is opened by removing the separation plate 123 located at the downstream part of the washing channel 122 by applying physical force to the separation plate 123 or performing chemical or thermal treatment on the separation plate 123 after the designated time for the reaction has elapsed, air fully filling the washing channel 122 comes out through the open part of the washing channel 122, and thus the fluid sample filling the reaction channel 142 flows to the washing channel 122 and fills the washing channel 122. The absorption pad may be inserted into the washing channel 122 so as to absorb the fluid sample or assist flow of the fluid sample.

The respective channels 122 and 142 of the chip 100 for analyzing fluids in accordance with the present invention may control the flow of the fluid sample through surface treatment using plasma, chemical, or other methods according to purposes thereof, and the widths of the washing channel 122 and the reaction channel 142 may be adjusted according to features of the surfaces of the respective channels 122 and 142.

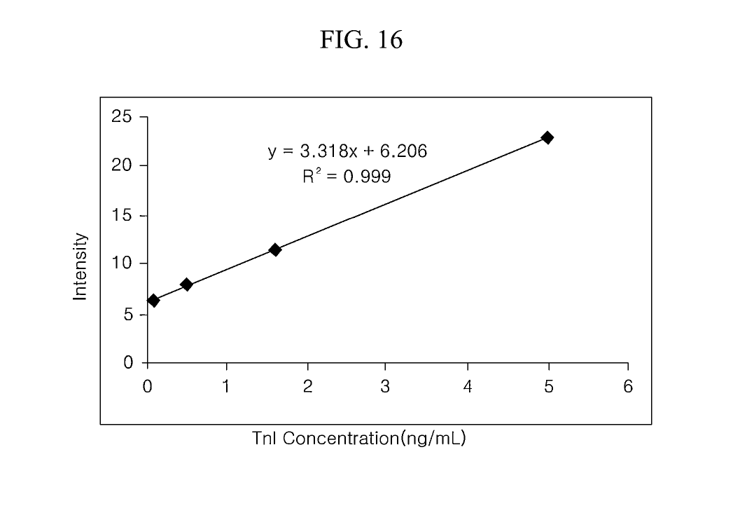

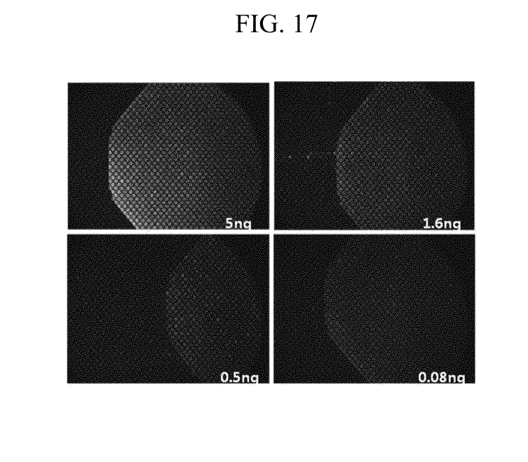

FIG. 16 is a graph representing reaction sensitivities of serum Trophonin I (TnI) according to concentration, measured using the chip for analyzing fluids in accordance with the present invention, and FIG. 17 illustrates four capture images of serum TnI according to concentration, measured using the chip for analyzing fluids in accordance with the present invention.

The object of the present invention is to adjust the flow and reaction time of a fluid sample to remove drawbacks of a flow reaction so as to maximally increase reaction sensitivity of the fluid sample, and thus test data regarding whether or not such an object is achieved is suggested.

Test Method

A serum which contains a TnI analyte at a concentration of 5 ng/mL is initially prepared, is successively diluted 1/3 by 1/3, and is then diluted by 1/6 to contain a TnI analyte at a concentration of 0.08 ng/mL for testing at a low concentration below the concentration of 0.5 ng/mL. Serums containing the TnI analyte at the respective concentrations are mixed with a sample buffer and a conjugate, and then 50 μL of these serum mixtures are injected into the chip for analyzing fluids. Here, fluorescent beads are used as the conjugate serving as a labeling substance.

A reaction is performed for 7 minutes from time when the serums reach the position of the detection unit 148, and after 7 minutes, the separation plate 123 is removed so as to allow the serums to flow down. Here, a time taken for the serums to flow down is about 30˜40 seconds.

Test Result

| | 5 ng | | | 1.6 ng | | | 0.5 ng | | | 0.08 ng | | |
|---|---|---|---|---|---|---|---|---|---|---|---|---|
| | Spot | Background | S − B | Spot | Background | S − B | Spot | Background | S − B | Spot | Background | S − B |
| 1 | 52.86 | 24.63 | 28.23 | 35.47 | 24.67 | 10.80 | 29.49 | 24.34 | 5.15 | 29.08 | 22.89 | 6.19 |
| 2 | 47.11 | 23.90 | 23.21 | 34.04 | 23.47 | 10.58 | 30.67 | 24.13 | 6.54 | 27.26 | 22.31 | 4.96 |
| 3 | 45.35 | 23.96 | 21.29 | 33.80 | 22.93 | 10.87 | 34.06 | 24.44 | 9.62 | 28.92 | 22.48 | 6.43 |
| 4 | 44.21 | 23.25 | 20.97 | 39.93 | 24.32 | 15.62 | 32.98 | 24.05 | 8.93 | 30.12 | 23.92 | 6.20 |
| 5 | 46.54 | 24.53 | 22.02 | 34.71 | 24.50 | 10.21 | 33.78 | 24.09 | 9.69 | 30.41 | 22.59 | 7.83 |
| 6 | 45.78 | 24.46 | 21.32 | 34.53 | 23.78 | 10.75 | 31.83 | 23.83 | 8.00 | 29.10 | 22.36 | 6.74 |
| Mean | | | 22.85 | | | 11.47 | | | 7.99 | | | 6.39 |
| STDEV | | | 2.75 | | | 2.05 | | | 1.82 | | | 0.93 |
| CV | | | 12.03 | | | 17.83 | | | 22.78 | | | 14.53 |

After the reaction of serum TnI of the respective concentrations is completed, images of serum TnI at the spot and the background are captured at a wavelength range of 660/680 nm, and sensitivities of serum TnI of the respective concentrations are measured using an image J program. FIG. 16 is a graph representing sensitivities of TnI according to concentration, and FIG. 17 illustrates the capture images of TnI according to concentration.

As can be seen from the test result, the chip 100 for analyzing fluids in accordance with the present invention may exhibit sufficient reproducibility and reliability in reaction until at least a concentration of 0.08 ng/mL

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A chip for analyzing fluids comprising:
a main body provided with an inlet through which a fluid is injected into the chip for analyzing fluids;
at least one reaction channel, which branches off from the main body and serves as an independent channel to which the fluid moves, and in which a reaction of an analyte contained in the fluid occurs; and
at least one washing channel formed within the main body and filled with the fluid coming out of the at least one reaction channel after the reaction has been completed.

2. The chip for analyzing fluids according to claim 1, wherein the downstream end of the at least one reaction channel is an open end, and the downstream end of the least one washing channel is a closed end.

3. The chip for analyzing fluids according to claim 2, further comprising at least one separation plate provided on the at least one washing channel and opening a part of the main body to deform the downstream end of the at least one washing channel into an open end when chemical treatment or thermal treatment of the at least one separation plate is performed or physical force is applied to the at least one separation plate.

4. The chip for analyzing fluids according to claim 1, wherein at least one absorption pad to absorb or move the fluid is inserted into the at least one washing channel.

5. The chip for analyzing fluids according to any one claim 1, wherein the at least one reaction channel and the at least one washing channel sequentially control the flow of the fluid through opening of the at least one separation plate.

6. The chip for analyzing fluids according to claim 1, wherein the at least one reaction channel branches off from the main body at a designated angle to the at least one washing channel.

7. The chip for analyzing fluids according to claim 1, wherein the at least one reaction channel branches off from the main body at right angles to the at least one washing channel.

8. The chip for analyzing fluids according to claim 1, wherein the main body is formed by connecting an upper plate and a lower plate.

9. The chip for analyzing fluids according to claim 8, further comprising at least one joining solvent inlet through which a joining solvent to join the upper plate and the lower plate is injected into the chip for analyzing fluids.

10. The chip for analyzing fluids according to claim 1, wherein the at least reaction channel is formed by connecting a capillary tube plate formed integrally with the main body and a reaction slide inserted into an insertion groove formed on the main body.

11. The chip for analyzing fluids according to claim 1, wherein at least a part of the at least one reaction channel has a slope gradient such that a height difference of the reaction channel is gradually increased in the downstream direction.

12. The chip for analyzing fluids according to claim 1, wherein a resistance part decreasing the width of the at least one reaction channel is provided at at least a part of the at least one reaction channel.

13. A chip for analyzing fluids comprising:
a reaction unit provided with a reaction channel in which a fluid injected through an inlet into the chip for analyzing fluids flows and a reaction of an analyte contained in the fluid occurs; and
a main body provided with a washing channel which is filled with the fluid coming out of the reaction channel after the reaction has been completed,
wherein the reaction unit is connected to the main body so as to branch off from the main body at a designated angle.

14. The chip for analyzing fluids according to claim 13, wherein the downstream end of the reaction channel is an open end, and the downstream end of the washing channel is a closed end.

15. The chip for analyzing fluids according to claim 13, further comprising at least one separation plate provided on the one washing channel and opening a part of the main body to deform the downstream end of the washing channel into an open end when chemical treatment or thermal treatment of the at least one separation plate is performed or physical force is applied to the at least one separation plate.

16. The chip for analyzing fluids according to claim 13, wherein at least one absorption pad to absorb or move the fluid is inserted into the washing channel.

17. The chip for analyzing fluids according to any one claim 13, wherein the reaction unit includes:
a capillary tube plate formed integrally with the main body; and
a reaction slide inserted into an insertion groove formed on the main body.

18. The chip for analyzing fluids according to any one claim 13, wherein the reaction unit is integrally formed inserted into an insertion groove formed on the main body.

19. The chip for analyzing fluids according to claim 13, wherein at least a part of the reaction channel has a slope gradient such that a height difference of the reaction channel is gradually increased in the downstream direction.

20. The chip for analyzing fluids according to claim 13, wherein a resistance part decreasing the width of the reaction channel is provided at at least a part of the reaction channel.
